(19) United States
(12) Patent Application Publication
(10) Pub. No.: US 2025/0336987 A1
(43) Pub. Date: Oct. 30, 2025

(54) CELL FRAME AND ARRANGEMENT FOR AN ELECTROCHEMICAL SYSTEM AND ELECTROCHEMICAL SYSTEM

(71) Applicant: Reinz-Dichtungs-GmbH, Neu-Ulm (DE)

(72) Inventors: Oliver CLAUS, Laichingen (DE); Manuel KAMM, Buch (DE); Jonas LEISCHER, Neu-Ulm (DE); Andreas MICHALKE, Ulm (DE); Franz SCHWEIGGART, Pfaffenhofen (DE); Markus WAHLS, Neu-Ulm (DE); Hans WALDVOGEL, Krumbach (DE); Tobias WOLF, Neu-Ulm (DE)

(21) Appl. No.: 19/189,100

(22) Filed: Apr. 24, 2025

(30) Foreign Application Priority Data
Apr. 25, 2024 (DE) 20 2024 102 084.7

(51) Int. Cl. H01M 8/0254; C25B 9/23; C25B 9/60; C25B 9/77; C25B 13/05; C25B 15/08; H01M 8/0273; H01M 8/0284; H01M 8/1004; H01M 8/242

(52) U.S. Cl. CPC H01M 8/0254; C25B 9/23; C25B 9/60; C25B 9/77; C25B 13/05; C25B 15/08; H01M 8/0273; H01M 8/0284; H01M 8/1004; H01M 8/242

(57) ABSTRACT

The present disclosure relates to a cell frame for an electrochemical system, comprising an outer region that defines at least one through-opening and a flow field, and a fluid guide structure disposed between the through-opening and the flow field, the fluid guide structure configured to guide a fluid from the through-opening to the flow field or vice versa, wherein the fluid guide structure has a metallic support element, which is connected to the outer region of the cell frame via at least one elastomeric connecting section.

### CROSS REFERENCE TO RELATED APPLICATION

This application claims priority to German Utility Model Application No. 20 2024 102 084.7, entitled “CELL FRAME AND ARRANGEMENT FOR AN ELECTROCHEMICAL SYSTEM AND ELECTROCHEMICAL SYSTEM”, filed Apr. 25, 2024. The entire contents of the above-identified application is hereby incorporated by reference for all purposes.

### TECHNICAL FIELD

The present disclosure relates to a cell frame and an arrangement for an electrochemical system and an electrochemical system. The electrochemical system can be a fuel cell stack, an electrolyzer or a redox flow battery, for example.

### BACKGROUND AND SUMMARY

In general, electrochemical systems such as electrolyzers or fuel cell stacks typically comprise a stack of individual electrochemical cells, each having a plurality of layers including at least one separator plate and a membrane electrode assembly (MEA), each individual cell being bounded by two adjacent separator plates. The stack of individual electrochemical cells can have two end plates that press the individual electrochemical cells together and give the stack stability. Furthermore, the individual electrochemical cells can comprise gas diffusion layers (GDL) and/or porous transport layers (PTL), which are arranged between the separator plate and the membrane electrode assembly. The separator plate can fulfil several functions: indirect electrical contacting of electrodes of the membrane electrode assembly (MEA), separation of media such as water, oxygen or hydrogen and electrical connection of the neighboring individual electrochemical cells. The separator plate is often also referred to as a bipolar plate.

The separator plate comprises at least one through-opening, sometimes called a port, as an inlet or outlet for passing a fluid through the separator plate, a flow field having an electrochemically active region, and a fluid guide structure located therebetween for guiding the fluid between the through-opening and the flow field.

The separator plate can be single-layered or multi-layered, for example. While separator plates in fuel cells are often double-layered so that cooling fluid can flow between the two individual layers, separator plates in electrolyzers are usually single-layered as additional cooling is not necessary. Double-layered separator plates are sometimes also used in electrolyzer applications. In this case, for example, the flow field can be designed as an additional metallic layer, which is mounted on a metallic base plate to form the bipolar plate.

In addition to the aforementioned separator plates, MEA, GDL or PTL, other layers can also be provided. Cell frames and/or cell seals can be arranged between adjacent separator plates to seal the cells. The stack of individual electrochemical cells must be sealed off from an external space, as a fluid or medium inside the individual electrochemical cells is often under excess pressure compared to the external environment. The fluid may, for example, comprise hydrogen, air or oxygen, water and/or mixture(s) thereof. In an electrolyzer, the pressure difference between the environment and the inside of an electrochemical cell can often be more than 20 bar. For example, the pressure on the product side, for example the H₂ side, may be up to 40 bar, while the pressure on the reactant side, for example the H₂O side, is only up to 2 bar. It is therefore important to seal off the flow field of the fluid from the external environment and also within the electrochemical system. For this purpose, the electrochemical system can have at least one cell frame running around the outer edge of the individual electrochemical cell for each of the individual electrochemical cells in order to achieve a sealing effect. In addition, the electrolyzer can comprise one or more sealing layers or cell seals for each of the individual electrochemical cells in order to reinforce the sealing effect.

Sealing beads embossed or molded into the separator plates, elastomer seals molded onto a metallic layer of the separator plate, or combinations thereof are often used to seal the flow field and/or the through-openings. To avoid leaks, it is important that the elastomer seal is bonded as firmly as possible to the metal layer. If the elastomer seal no longer seals well, the separator plate including elastomer seal and metallic layer must be replaced during repair or maintenance. If the separator plate is to be reused, the elastomer seal must be removed at great expense and a new elastomer seal must be applied.

The aforementioned elastomer seals or sealing beads are located in the main force connection, i.e. along the direction of the compression force used to press the stack of separator plates together. Reliable pressing of the seals over the entire stack is therefore usually heavily dependent on manufacturing tolerances and operating situations. The operating pressures of modern electrolyzers, of up to 40 bar or even more, can therefore quickly become a problem with the seals currently used.

In conventional sealing concepts, a groove formed in the metallic layer is often provided to accommodate an elastomeric seal, whereby the elastomer seal is usually injection-molded into the groove. Due to the groove and the injection-molded elastomer seal, the space required in the pressing direction is relatively large. In addition, the metallic layer in such sealing concepts is in contact with the fluid, which has an influence on the choice of material for the metallic layer.

There is therefore a continuous need to further increase the fluid-tightness of the system, to prevent or at least reduce pressure loss or fluid loss and/or to increase the safety of the system. The present disclosure has been conceived to meet this need and/or to at least partially solve the aforementioned problems.

According to a first aspect, a cell frame for an electrochemical system is proposed. The cell frame comprises an outer region that defines at least one through-opening and a flow field, and a fluid guide structure arranged between the through-opening and the flow field for guiding a fluid from the through-opening to the flow field or vice versa. The fluid guide structure has a metallic support element, which is connected to the outer region of the cell frame via at least one elastomeric connecting section.

Such a cell frame is sometimes also known as a cell seal, as the cell frame extends in a frame shape around the electrochemically active region and is suitable for use in an electrochemical cell, for example for sealing the electrochemical cell. The cell frame can, for example, be provided on the cathode side and/or anode side in an electrochemical cell. The flow field usually has or is formed by an electrochemically active region. “Defining” the at least one through-opening and a flow field, respectively, is here for example meant as delimiting these structures.

The high pressure prevailing during operation of the electrochemical cell or the electrochemical system, particularly the high pressure on the cathode side, can place a heavy load on the fluid guide structure. In conventional systems, this deforms the elastomeric fluid guide structure. The pressure can greatly reduce the cross-sections of the fluid guide structure through which the fluid flows, thereby reducing the fluid flow. In addition, the pressure on the sealing line of the cathode chamber decreases, which has a detrimental effect on the sealing function. In order to at least partially mitigate these detrimental effects, the metallic support element in accordance with the present disclosure is proposed.

The metallic support element gives the fluid guide structure stability and helps to support or reinforce the fluid guide structure/fluid passages so that they are not excessively deformed during operation of the electrochemical system. The support element thus improves the mechanical support along the sealing line between the layers to be sealed, so that the layers adjacent to the support element can be reliably sealed at high system pressure. This increases security against leakage. Furthermore, higher differential pressures and/or compressions, and larger open cross-sections of the fluid passages are possible. The support element can therefore also be seen as a reinforcing element or stiffening element, as it reinforces or stiffens the fluid guide structure.

When the cell frame is used as intended, the fluid guide structure and its metallic support element are usually in contact with the fluid. The cell frame is usually designed so that the outer region does not come into contact with the fluid, see description below. This means that materials can be used for the outer region that are normally not suitable for use in the electrochemical system due to the contact with the fluid. For example, metals or combinations thereof can be used for the outer region, which are cheaper and/or easier to process than the materials conventionally used for the cell frame. Plastic can also be used. For example, the frame-shaped outer region can be made of a material that does not have to be corrosion-resistant. It is therefore possible for the outer region and the metallic support element to be made of different materials, in particular different metals. For example, the metallic support element is made of stainless steel, titanium or a titanium alloy. The outer region can be made of aluminum, an aluminum alloy, plastic, (non stainless) steel or stainless steel, for example.

The fluid guide structure often has a large number of fluid passages for passing the fluid therethrough. The fluid passages are often designed as recesses of a surface and typically extend between the through-opening and the flow field, for example in the shape of a channel. Webs, nubs or other shaped protrusions, which delimit the fluid passages, are formed between the recesses.

The fluid passages can be formed into the metal support element, for example by removing material or by embossing the support element. The latter means that the fluid passages are molded into the metal support element. The metal support element can have a thickness in the region between the fluid passages and/or outside the fluid passages that is the same as the thickness of the outer region. The fluid passages can also be created on the metal support element by molding elastomeric webs.

The fluid guide structure may have an elastomer region that is adjacent to the elastomeric connecting section and that typically extends in the direction of fluid flow between the through-opening and the flow field. Alternatively and/or in addition to the fluid passages in the metallic support element, the fluid guide structure may have a plurality of fluid passages that are formed in the elastomer region. The metallic support element can be arranged on the fluid passages of the elastomer region. In addition (if more than one support element is provided) or alternatively, the metallic support element can be arranged on a side of the elastomer region that is opposite the fluid passages. The support element can also be predominantly surrounded by elastomer so that it forms a reinforcement in the manner of a backbone seal. The support element may be arranged in such a way that it overlaps with the fluid passages of the elastomer region when viewed from above, thus in the stacking direction of the cell stack to be formed. The elastomer region can also have a receiving part for holding the support element. The receiving part typically has the same dimensions as the support element. The support element can be partially or completely embedded in the material of the elastomer region.

Sometimes the metallic support element and the elastomer region in the region outside the fluid passages and/or between the fluid passages can have a combined thickness which, at least in the compressed state of the cell frame, is the same as a thickness of the outer region. This can be the case, for example, if the elastomer region and the support element rest on each other or if the support element is embedded in the elastomer region.

The elastomeric connecting section ensures that the metal support element is connected to the outer region. There may be sections between the metallic support element and the outer region in which only the material of the elastomeric connecting section is present. An imaginary straight line, which extends parallel to the support element and through the material of the support element, can be drawn to the outer region. In the region between the support element and the outer region, the straight line runs through the material of the elastomeric connecting section. The elastomeric connecting section is often connected to the outer region and/or the metallic support element in a materially cohesive manner and/or a form-fitting manner, for example in a non-detachable form-fitting manner and/or a conditionally detachable form-fitting manner. In one embodiment, the elastomeric connecting section is molded onto the outer region and/or the metallic support element. It may be provided that the elastomeric connecting section has a sealing lip that extends between the metallic support element and the outer region, optionally at least from the through-opening to the flow field. It may be provided that the elastomeric connecting section has a sealing line support that extends between the metallic support element and the outer region. In some embodiments, the metal support element is only connected to the outer region by the elastomeric connecting section. Alternatively, at least one metal web can also be provided, which extends from the outer region to the support element and connects one with the other. The web is then provided in addition to the elastomeric connecting section. The web can be formed from the material of the outer region and/or embedded in the material of the elastomeric connecting section.

The cell frame can have an inner edge in the region of the through-opening. The cell frame can also have a recess that extends over the flow field. The recess can have an inner edge, too. Thus, the area of the flow field and/or of the at least one through-opening may be passage openings.

The cell frame can have the following sealing elements:
a first elastomeric sealing element that rests against the inner edge of the through-opening and projects laterally into the through-opening in order to seal the through-opening and/or
a second elastomeric sealing element that lies against the inner edge of the recess and projects laterally into the recess in order to seal the recess. Both of these elastomeric sealing elements may be molded to the respective inner edge, e.g. injection-molded.

It may be the case that only the first sealing element, or only the second sealing element, or a combination of both sealing elements are provided.

When used as intended, the cell frame is compressed together with other elements or layers. When the cell frame is compressed, the first sealing element and/or the second sealing element are typically in the force path and are compressed or deformed laterally, that is radially in the direction of the regions to be sealed, i.e. the through-opening or recess. This has the advantage that manufacturing tolerances and operating parameters play a less prominent role with regard to the sealing potential.

It may be provided that the first sealing element is in circumferential contact with the inner edge of the through-opening and/or that the second sealing element is in circumferential contact with the inner edge of the recess. When the cell frame is used as intended, the first sealing element and/or the second sealing element are usually in contact with the fluid. The first sealing element and/or the second sealing element can be designed in such a way that they prevent the outer region of the cell frame from coming into contact with the fluid.

The cell frame, for example the outer region of the cell frame, often has a first side, also referred to as first flat side and a second side, also referred to as second flat side, which are arranged opposite each other and generally extend in a flat manner. It may be provided that, in an uncompressed state of the cell frame, the first sealing element and/or the second sealing element protrude beyond the first side and/or the second side of the cell frame in a vertical direction-i.e. the pressing direction, which is aligned parallel to a surface normal of the cell frame, for example the z-direction. The horizontal direction is parallel to the cell frame or cell frame plane. When pressing the cell frame, the vertical protrusion is compressed laterally in the direction of the recess or through-opening, so that the corresponding sealing element is essentially flush with the cell frame when compressed.

In many embodiments, the first sealing element is molded onto the inner edge of the through-opening and/or the second sealing element is molded onto the inner edge of the recess. In these embodiments, the first sealing element and/or the second sealing element can be designed in particular as edge-molded sealing profiles.

The outer region and/or the metallic support element (apart from any recesses or fluid passages for guiding fluid) are usually designed as a flat plate, optionally as a smooth sheet. Grooves or beads for accommodating elastomeric seals are not necessary due to the first sealing element and the second sealing element, which may be molded onto the inner edges of the outer region as described above.

In addition to the elastomeric connecting section, the above-mentioned sealing lip can extend along the first sealing element and/or the second sealing element or can additionally be a component of the first sealing element and/or the second sealing element.

The elastomeric connecting section, the elastomer region of the fluid guide structure, the first elastomeric sealing element and/or the second sealing element may be formed from the same elastomer and may be formed as integral components of a single elastomeric element. Conceivable elastomers include FKM (fluoroelastomer), silicone rubber or NBR rubber (nitrile butadiene rubber), PUR (polyurethane), NR (natural rubber), FFKM (perfluoro rubber), SBR (styrene butadiene rubber), BR (butadiene rubber), FVMQ (fluorosilicone), CSM (chlorosulfonated polyethylene), HNBR (hydrogenated nitrile-butadiene rubber), ACM (acrylate rubber), AEM (acrylate-ethylene rubber), EPDM (ethylene-propylene-diene rubber), IIR (butyl rubber) or mixtures of the aforementioned materials.

In some embodiments, the recess and the through-opening form a common opening in the cell frame. In this case, the recess and the through-opening can be spatially separated from each other by the fluid guide structure, they may only be separated from each other by the fluid guide structure. This means that only the material of the fluid guide structure runs between the recess and the through-opening, without any material from the outer region being present.

The cell frame can have at least two through-openings. On the anode side, one of these through-openings can then be configured as an inlet for the fluid, while the other of the through-openings can be designed as an outlet for the same fluid and another fluid. On the cathode side, both through-openings can be configured as fluid outlets. The recess is then arranged between the two through-openings, for example in the direction of fluid flow between the two through-openings.

According to another aspect, an arrangement for an electrochemical system is proposed. The arrangement has a cell frame of the type described above and a bipolar plate. The bipolar plate has at least one through-opening and a flow field with an electrochemically active region, the cell frame and the bipolar plate being positioned relative to one another in such a way that the through-openings of the bipolar plate and the through-openings of the cell frame are arranged one above the other and the cell frame surrounds the flow field with the electrochemically active region of the bipolar plate.

It is possible that the outer region of the cell frame and a plate body of the bipolar plate are made of different materials.

The bipolar plate can be essentially flat between the flow field and the through-opening. Furthermore, the bipolar plate can be essentially flat in a first region adjacent to the through-opening and circumferentially around the through-opening and/or in a second region adjacent to the flow field and circumferentially around the flow field. In particular, the bipolar plate has no sealing elements such as sealing beads, elastomer seals and/or recesses for accommodating elastomer seals in the aforementioned flat regions. The sealing of the through-opening and/or the flow field as well as the fluid line between the through-opening and the flow field can therefore be performed by the cell frame described above, while the bipolar plate is configured for the electrical contacting and separation and/or distribution of the media. As the bipolar plate itself has no elastomer seal around the through-openings and the flow field, the bipolar plate can be removed, serviced, possibly cleaned, possibly recoated and reused relatively easily when servicing is required.

The cell frame performs sealing functions and ensures that the through-openings of the bipolar plate are sealed by means of the first sealing element(s) and the flow field of the bipolar plate is sealed by means of the second sealing element. In addition, the cell frame performs the fluid conduction function between the through-opening and the flow field by means of the fluid guide structure. Typically, the flow field of the bipolar plate has a large number of channels that are molded into the bipolar plate, for example by embossing, hydroforming and/or deep drawing. The bipolar plate can be single-layered or double-layered, for example. The bipolar plate can be made of titanium or stainless steel, for example.

It may be provided that the through-opening formed in the bipolar plate is smaller than the through-opening formed in the cell frame. This way, the first sealing element and/or the second sealing element of the cell frame make contact with the bipolar plate. A plate body of the cell frame and a plate body of the bipolar plate can be made of different materials or can be made of the same materials.

Two cell frames of the type described above can be provided for each bipolar plate. The arrangement can have two cell frames that are arranged on opposite sides of the bipolar plate, the first sealing elements of the cell frames sealing the through-opening of the bipolar plate on both sides of the bipolar plate and/or the second sealing elements of the cell frames sealing the electrochemically active region of the bipolar plate on both sides of the bipolar plate. The first of the two cell frames can be provided on a cathode side of the bipolar plate, while the second of the two cell frames can be provided on an anode side of the bipolar plate. The respective cell frames may be arranged with respect to the bipolar plate in such a way that their fluid guide structures face the bipolar plate and, in particular, rest on the bipolar plate.

In addition, the arrangement can also have at least one insulation layer and/or insulation coating for electrical insulation. The insulation layer and/or insulation coating can be arranged on one side or on both sides of the cell frame. The insulation layer and/or insulation coating can be arranged between the cell frame and the bipolar plate. Alternatively, the cell frame can be arranged between the insulation layer and the bipolar plate. Optionally, there is no additional layer or coating between the first sealing element or the second sealing element and the bipolar plate, so that the respective sealing element rests directly on the bipolar plate. The respective sealing element is thus designed to seal the insulating layer against the at least one through-opening of the cell frame and/or the recess of the cell frame, so that the insulating layer does not come into contact with the fluid when the arrangement is used as intended. The first sealing element and/or the second sealing element are often also electrically insulating.

The arrangement can also have a membrane electrode assembly (MEA), which is located between two cell frames, and/or a porous transport layer (PTL) or gas diffusion layer (GDL), which are arranged between the MEA and the flow field of the bipolar plate.

According to a further aspect, an electrochemical system is proposed, optionally an electrolyzer or fuel cell stack. The system comprises a plurality of cell frames of the type described above, a plurality of bipolar plates of the type described above and/or a plurality of stacked arrangements of the type described above.

The electrochemical system may be, for example, an electrolyzer. However, the present specification is not limited to an electrolyzer. The electrochemical system may alternatively also be a fuel cell system or a redox flow battery. In one embodiment, where the electrochemical system is an electrolyzer, water is often the reaction medium, while hydrogen or oxygen may be the product medium/media. In a fuel cell system, hydrogen and oxygen are often the reaction media, while water is the product medium.

Embodiments of the cell frame, the bipolar plate, the arrangement and the electrochemical system are shown in the attached figures and are explained in more detail in the following description. Shown in the figures are:

### BRIEF DESCRIPTION OF THE FIGURES

FIG. 1 shows an exploded view of an individual cell of a prior art electrolyzer.

FIG. 2 shows a top view of a prior art bipolar plate.

FIG. 3 shows schematic perspective view of a bipolar plate according to one embodiment.

FIG. 4 is a schematic perspective view of part of an arrangement having two cell frames and a bipolar plate according to one embodiment, with the support element omitted.

FIG. 5 shows an enlargement of a region of FIG. 4 with a metallic support element.

FIG. 6 is a schematic perspective view of a part of an arrangement having a cell frame and a bipolar plate according to one embodiment.

FIG. 7 is a schematic perspective view of a part of an arrangement having a cell frame and a bipolar plate according to one embodiment but without elastomeric elements.

FIG. 8 is a schematic perspective view of a part of an arrangement having a cell frame and a bipolar plate according to a further embodiment without elastomeric elements.

FIG. 9 shows an enlargement of a region of FIG. 8.

FIG. 10 is a schematic perspective view of part of an arrangement having a cell frame and a bipolar plate according to one embodiment, with the support element omitted.

FIG. 11 is a schematic perspective view of a cathode-side cell frame according to one embodiment.

FIG. 12 is a schematic perspective view of an anode-side cell frame according to one embodiment.

FIG. 13 is a schematic perspective view of a composite of bipolar plate and cathode-side and anode-side cell frames, with a view of the cathode side.

FIG. 14 is a schematic perspective view of a composite of bipolar plate and anode-side and cathode-side cell frames, with a view of the anode side.

FIGS. 15A and 15B show a sectional view of a composite of a bipolar plate and cathode-side and anode-side cell frames in the region of a through-opening, in the uncompressed state (FIG. 15A) and in the compressed state (FIG. 15B).

FIGS. 16A and 16B show sections of a cell frame having an embossed metallic support element.

FIG. 17 shows an enlargement of a section of FIG. 16B.

### DETAILED DESCRIPTION

Here and in the following, recurring features in different figures are each designated with the same or similar reference signs.

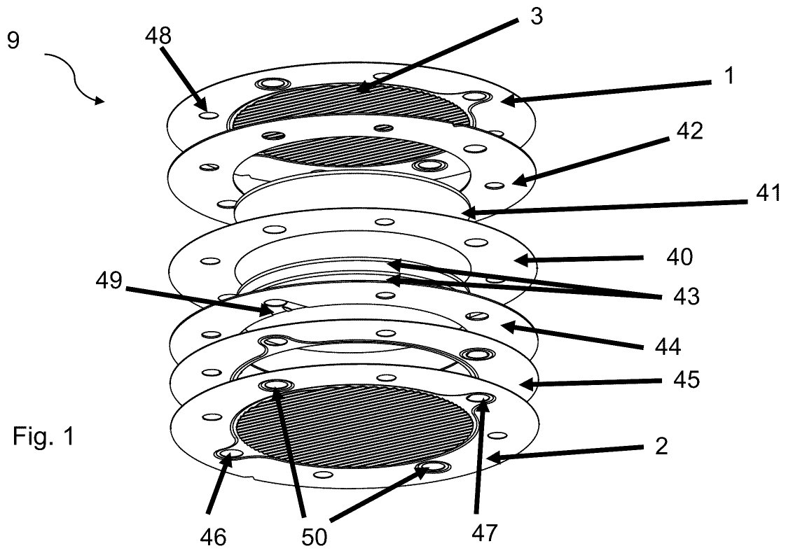

FIG. 1 shows an exploded view of an individual electrochemical cell 9, wherein the cell 9 is part of an electrolyzer. Electrolyzers typically comprise a large number of stacked individual cells 9. The individual cell 9 comprises two separator plates 1 and 2, two cell frames 42 and 44, a sealing layer 45, and a membrane electrode assembly 40 having media diffusion structures 41 and 43. For example, the media diffusion structure 43 comprises layers of carbon nonwoven material, while the media diffusion structure 41 comprises metal, e.g. titanium. Here, the separator plate 1 is arranged, for example, on the anode side of the individual cell 9. In the exemplary embodiment shown, the separator plate 2 is arranged on the cathode side of the individual cell 9. The individual layers are compressed together to form an individual cell. The individual layers each have fluid passages 46, 47, 50, arranged in alignment one above the other, for the inward and outward passage of water, oxygen and hydrogen, as well as positioning holes 48.

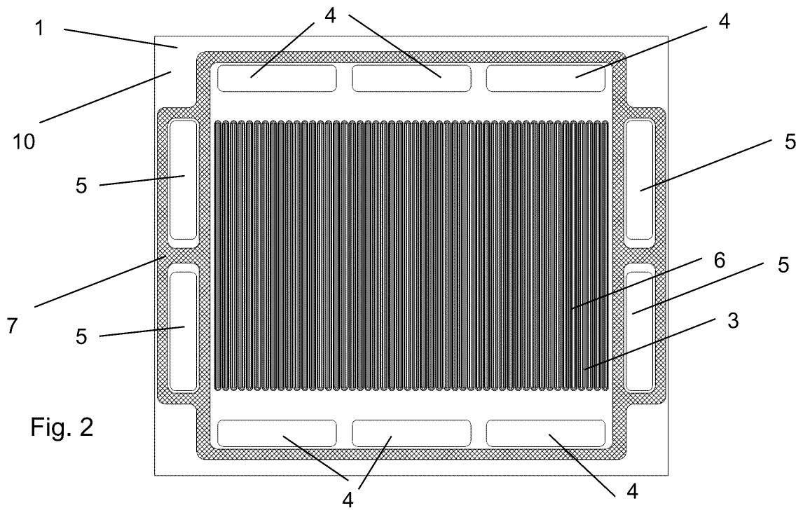

A flow field of the separator plate 2 is defined by projecting the cell frame 44 onto the separator plate 2. A flow field 3 of the separator plate 1 is defined by projecting the cell frame 42 onto the separator plate 1. The cell frame 42 has distribution channels (not shown) for distributing the water that is fed in. The through-openings 46, 47 are fluidically connected to the flow field 3 so that a medium can be routed from the through-opening 46 to the flow field 3, or from the flow field 3 to the through-opening 47. When a potential is applied, hydrogen (or oxygen) can be generated in the electrolyzer from the supplied water. The generated hydrogen (or oxygen) can be discharged through the distribution channels 49 in the cell frame 44. It can then leave the cell through the through-openings 50. While the separator plates 1 shown in FIG. 1 have a round outer contour, other shapes are also possible. For example, the separator plates 1, 2 can have a rectangular outer contour, see FIG. 2.

The separator plates 1, 2 from FIGS. 1 and 2 are exemplary separator plates according to the state of the art, which are also referred to below as bipolar plates 1, 2.

As already indicated above, a pressure difference between the external environment and the interior of the electrochemical cell 9 can be more than 20 bar. The pressure on the product side, for example the hydrogen side, is often up to 40 bar, while the pressure on the reactant side, for example the water side, is only up to 2 bar. Sealing structures are therefore provided to seal the individual areas from each other.

For example, elastomer seals are used, which are arranged around the regions to be sealed, e.g. the flow field 3 or through-openings 46, 47, 50. The elastomer seal is usually not provided over the entire surface, but only on the regions of the separator plate 1, 2 to be sealed and is fixedly connected to the plate body of the respective separator plate 1, 2.

FIG. 2 shows a schematic top view of a separator plate 1 for an electrolyzer. The separator plate 1 comprises a metallic layer 10, which for example may consist at least predominantly or completely of titanium or stainless steel or alloys thereof. The metallic layer 10 can have a thickness of at least 0.1 mm and/or at most 0.8 mm. The separator plate 1 has a flow field 3, which is designed to distribute the water supplied from the through-openings 4 over as large an area as possible and to discharge it again together with the generated oxygen. Optional channel structures 6 are provided in the flow field 3 for this purpose. The through-openings 5 are designed to discharge hydrogen, whereby the through-openings 5 are surrounded by an elastomer seal 7 on the side of the separator plate that is shown. The elastomer seal 7 ensures that the water cannot escape and that hydrogen or ambient air cannot enter.

Separator plates of fuel cells are often designed in two layers so that each layer can be processed individually, for example embossed, surface-treated, injection-molded, etc. Separator plates 1, 2 of electrolyzers, on the other hand, are often designed as a single layer. For this reason, sealing elements 7 of separator plates in electrolyzers must be provided on both sides of a single layer 10. In addition, the arrangement of sealing elements in a separator plate of an electrolyzer leads to multiple different sealing elements being present in a confined space. The sealing elements are also arranged alternately to seal both sides of the separator plate. The separator plate is therefore highly complex with respect to sealing the through-openings 4, 5 and the flow field 3, both due to the small distance between the sealing elements and due to the alternating arrangement.

As mentioned at the beginning, there is therefore a constant need to improve the fluid-tightness of electrolyzers and fuel cell stacks.

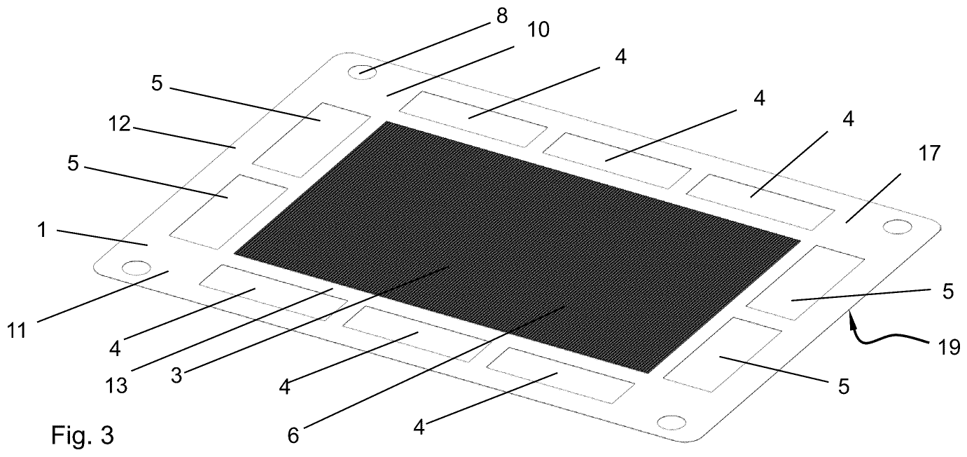

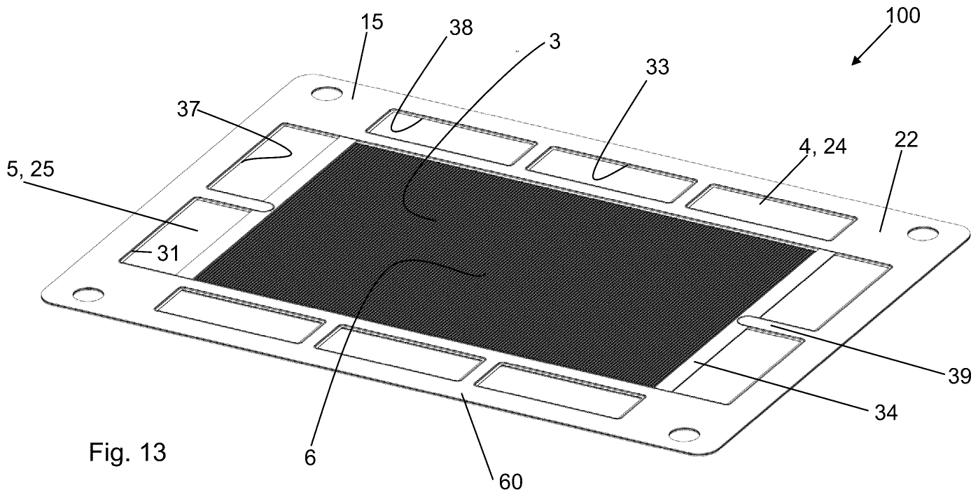

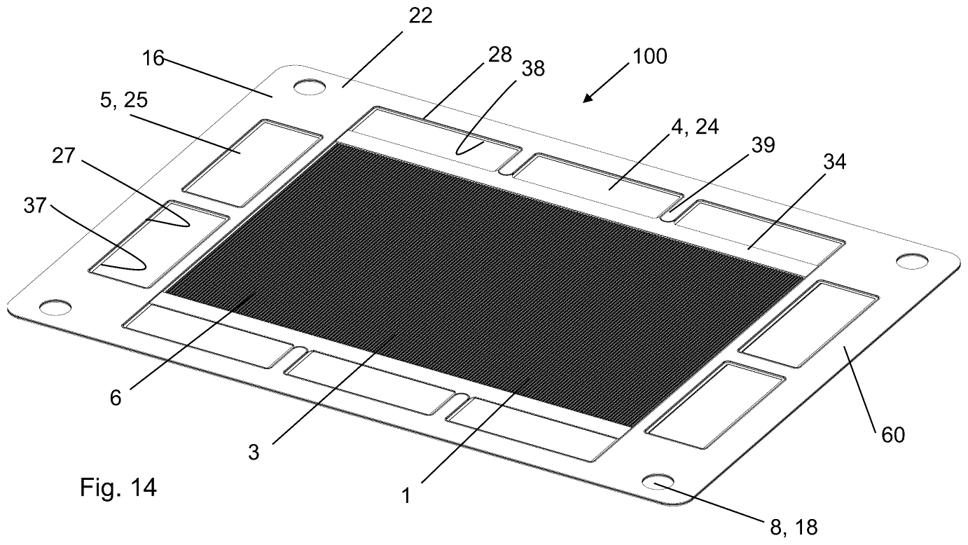

FIGS. 3-17 relate to various aspects and embodiments of the present disclosure.

FIG. 3 shows a top perspective view of a bipolar plate 1 according to one embodiment of the present disclosure. Like the bipolar plate 1 of FIGS. 1 and 2, the bipolar plate of FIG. 3 also has a flow field 3 having an electrochemically active region and a plurality of through-openings 4, 5 for the passage of a fluid. The flow field 3 has a large number of channels 6, which are molded into the bipolar plate 1, for example by hydroforming, embossing and/or deep drawing. The bipolar plate 1 is usually single-layered, but can also be double-layered, for example in an embodiment in which the flow field 3 is mounted as an additional layer on a base plate. Centering holes 8 are often provided to accommodate centering pins so that the bipolar plate 1 can be aligned or centered.

In comparison with and in contrast to the bipolar plate 1 of FIGS. 1 and 2, it is noticeable that the bipolar plate 1 is essentially flat between the flow field 3 and the through-opening 4, 5, i.e. it is configured as a flat surface there. The bipolar plate is designed as a flat, even plate outside the flow field 3 and apart from any through-openings 4, 5, 8, for example everywhere outside the aforementioned regions 3, 4, 5, 8. The flat region 11 of the bipolar plate comprises, for example, a first sub-region 12 and a second sub-region 13. The first flat region 12 is adjacent to the through-opening 4, 5 and completely surrounds the through-opening 4, 5. The second flat region 13 is adjacent to the flow field 3 and completely surrounds it. The bipolar plate has no sealing elements or other protrusions or recesses in the aforementioned regions 11, 12, 13. These regions 11, 12, 13 are therefore free of sealing beads, elastomer seals, elastomer bulges and/or recesses for accommodating sealing elements.

The bipolar plate 1 has two opposite sides 17, 19, whereby in FIG. 3 only the first side 17 (front side of the bipolar plate 1) is visible and the second side 19 (rear side of the bipolar plate 1) is concealed from the viewer. Due to the absence of sealing elements in the bipolar plate 1, both sides 17, 19 of the bipolar plate 1 can have the same, that is an identical design, so that the bipolar plate 1 has an axis of rotational symmetry running through the plane of the bipolar plate 1 and parallel to the plane of the bipolar plate 1. A rotation of 180° around this axis of rotational symmetry results in the same arrangement of the bipolar plate 1, apart from the fact that the channels 6 in the flow field 3 are oriented in the opposite direction. In the embodiment shown, the bipolar plate 1 is single-layered and made of titanium. Other materials, such as a titanium alloy or stainless steel, are also possible alternatives.

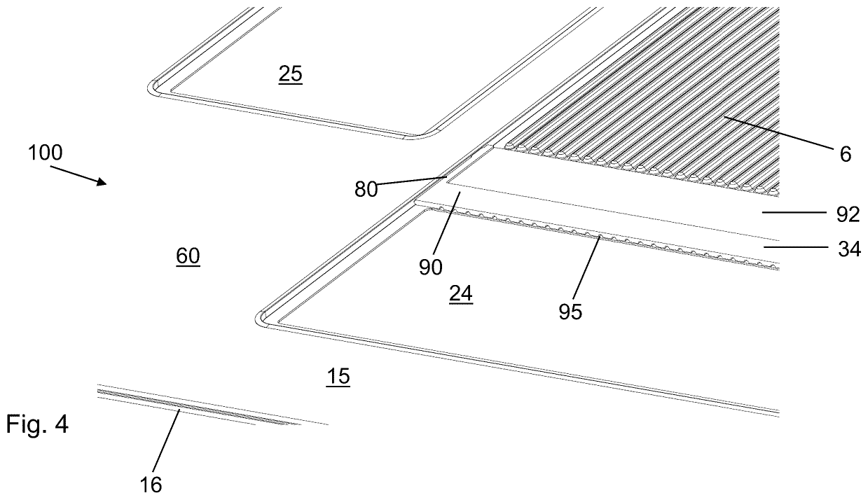

The sealing of the flow field 3 and the sealing of the fluid passages 4, 5 are achieved by a cell frame 15, 16, which is described below. FIGS. 4-17 show various aspects of the cell frame 15, 16. The cell frame 15, 16 comprises an outer region 60 which has at least one through-opening 24, 25 and a recess 23, wherein the edges of the recess 23 are arranged around the area corresponding to the flow field 3 of the bipolar plate. In an orthogonal projection of the cell frame 15, 16 into the plane of the bipolar plate, the flow field 3 may be situated within the recess 23. The outer region 60 can be regarded as a frame-shaped layer.

Furthermore, the cell frame 15, 16 has a fluid guide structure 34 arranged between the through-opening 24, 25 and the flow field for guiding a fluid from the through-opening 24, 25 to the flow field or vice versa. The fluid guide structure 34 is sometimes also called the distribution or transfer region, because fluid is distributed there from the through-opening 24, 25 to the flow field 3 or to the electrochemically active region 3 or is guided from the flow field 3 or from the electrochemically active region 3 to the through-opening 24, 25.

The fluid guide structure 34 has a metallic support element 70, which is connected to the outer region 60 of the cell frame 15, 16 via at least one elastomeric connecting section 80. The fluid guide structure 34 has a plurality of fluid passages in the form of recesses 75, 95, which guide the fluid from the through-opening 24 to the flow field or vice versa. Each recess 75, 95 may, for example, extend from the through-opening 24 to the flow field in the form of a channel between elongated protrusions. In the example embodiments shown, the recesses 75, 95 are arranged parallel to one another. However, several shorter recesses are also conceivable, which are arranged in a row and do not have to extend over the entire length of the region between the through-opening 24 and the flow field. Nub-like protrusions can also be provided, with the fluid passages being formed between the nubs.

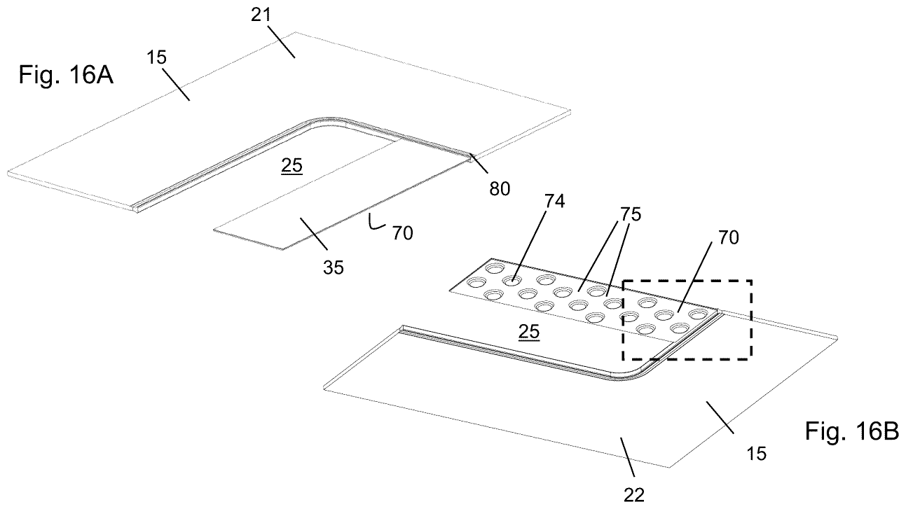

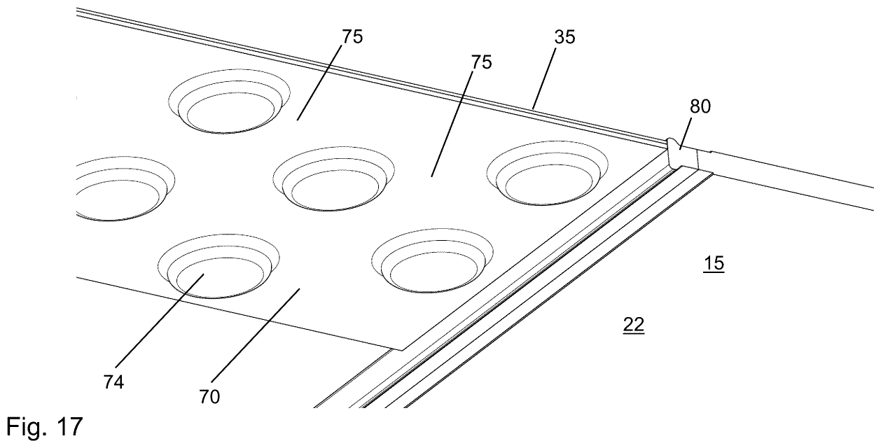

An example of a cell frame 15 with nub-like protrusions is shown in FIGS. 16A, 16B and 17, wherein FIG. 16A shows a section of a cell frame 15 from above, while FIG. 16B shows the same section from below, they are further oriented differently in order to optimize their demand of space in the illustration. FIG. 17 shows an enlargement of the region denoted with a dashed line in FIG. 16B. In this case, the metallic support element 70 has a plurality of embossed nubs 74, which in their interspaces form fluid passages 75. In the example embodiment shown, the metal support element 70 is provided with an elastomer layer 35. The elastomer layer 35 connects the metallic support element 70 to the outer region 60 of the cell frame and thus has the characteristics and provides the effect of the connecting section 80 described above. In order to increase stability, an additional connecting section 80 can optionally be provided (see FIG. 17), which is arranged laterally between the metallic support element 70 and the outer region 60 and is also covered with the elastomer layer 35. The nub-like projections 74 can form depressions on the opposite side of the support element 70 (not shown). In order to reduce the elasticity or adjust it as required, these recesses can be filled with a material, for example with the material of the elastomer layer 35. However, other materials are also conceivable for filling the recesses.

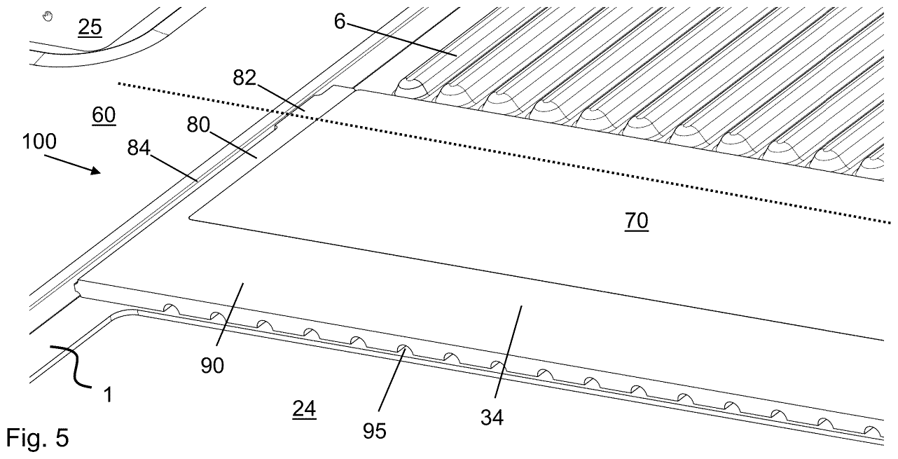

In the embodiment of FIGS. 4, 5, the fluid guide structure 34 has an elastomer region 90, which adjoins the elastomeric connecting section 80 and extends between the through-opening 24 and the flow field 3, in particular in the direction of flow between the elements 24 and 3. The recesses 95 are formed in the elastomer region 90. The elastomer region 90 can optionally have a receiving part 92, which is designed to receive the metallic support element 70. The receiving part 92 may have a depth that corresponds to the thickness of the support element 70, whereby the support element 70 is arranged in the receiving part 92 or rests on the elastomer region 90. The metallic support element can alternatively or additionally be embedded in the material of the elastomer region 90. The metallic support element 70 and the elastomer region 90 can have a combined thickness in the region between the recesses 95—i.e. outside the recesses 95—which, at least in the compressed state of the cell frame or the arrangement 100, is the same as a thickness of the outer region 60.

The metallic support element 70 is arranged at least in the region of the recesses 95 of the elastomer region 90 and supports the elastomer region 90 there or reinforces the elastomer region 90. In FIGS. 4, 5 it can be seen that the metallic support element 70 is arranged on a side of the elastomer region 90 that is opposite the recesses 95. Alternatively (not shown), the metallic support element 70 can also be arranged on the same side as the recesses 95. In this case, the support element 70 bridges the recesses 95.

The elastomer region 90 can be more evenly loaded by means of the support element 70, as the support element 70 supports the elastomer region 90 in the region of the recesses 95. An imaginary straight line, in FIG. 5 indicated as a dotted line, which extends parallel to the support element 70 and through the material of the support element 70, can be drawn to the outer region 60. In the region between the support element 70 and the outer region 60, the straight line runs through the material of the elastomeric connecting section 80.

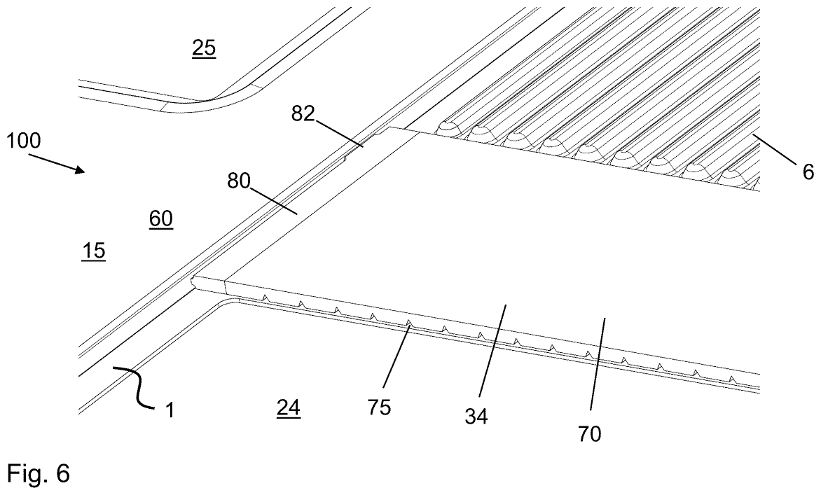

In the embodiments of FIGS. 6-10, the recesses 75 of the fluid guide structure 34 are molded, e.g. embossed, into the metallic support element 70. The metal support element 70 has a thickness in the region between the recesses—i.e. in the region outside the recesses 75—that is the same as the thickness of the outer region 60. The recesses 75 can have a smaller flow cross-section than the recesses 95, as the metallic support element 70 is less pliable than the elastomer region 90. The outer region 60, the bipolar plate and the metallic support element 70 can be designed as a flat plate, optionally as a smooth sheet, cf. FIGS. 4-5 and FIGS. 6-10 (except for the recesses 75 of the support element).

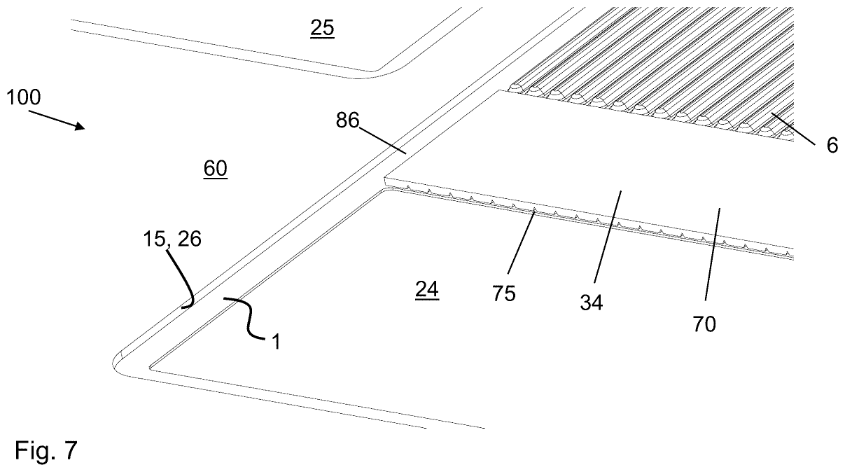

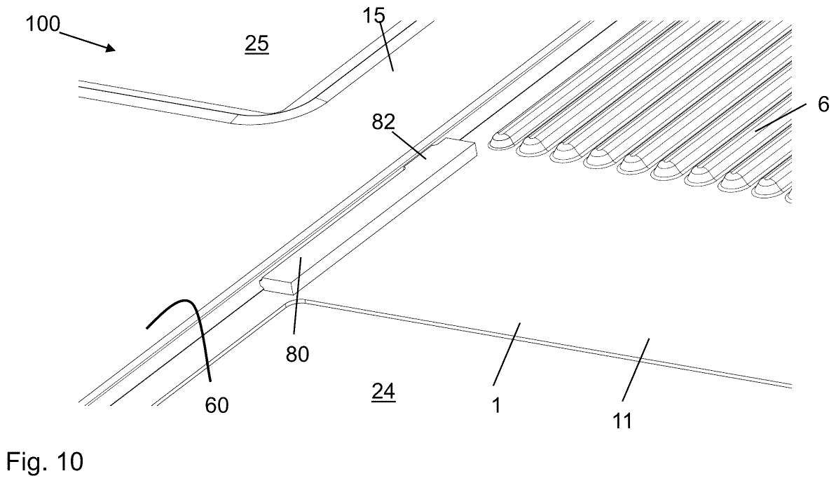

In FIG. 7, the elastomeric connecting section 80 is omitted for clarity. The intermediate space 86 into which the elastomeric connecting section is inserted or injected can be seen. In FIG. 10, the connecting section 80 is shown, but the support element 70 is omitted.

It may be provided that the elastomeric connecting section 80 has a sealing line support 82 and a sealing lip 84, which extend between the metallic support element 70 and the outer region 60 and from the through-opening 24 to the flow field. In addition to the elastomeric connecting section 80, the sealing lip 84 can extend along a first sealing element 31 and/or a second sealing element 32 (see below) or can additionally be a component of the first sealing element 31 and/or the second sealing element 32.

The outer region 60 and the metallic support element 70 can be made of different materials, in particular different metals. For example, the metallic support element 70 can be made of stainless steel, titanium or a titanium alloy. The outer region 60 can be made of aluminum or an aluminum alloy, plastic or stainless steel.

The elastomeric connecting section 80 may be connected to the outer region 60 and the metallic support element 70 in a materially cohesive manner and/or in a form-fitting manner. The form-fit can be formed, for example, on laterally projecting shaped elements of the support element 70 or outer region 60 that are configured for this purpose. Alternatively, a conditionally detachable form-fit, e.g. a puzzle-like connection, can also be present at recesses in the outer region 60 and/or in the support element 70. Optionally, the elastomeric connecting section is molded onto the outer region 60 and/or the metallic support element 70.

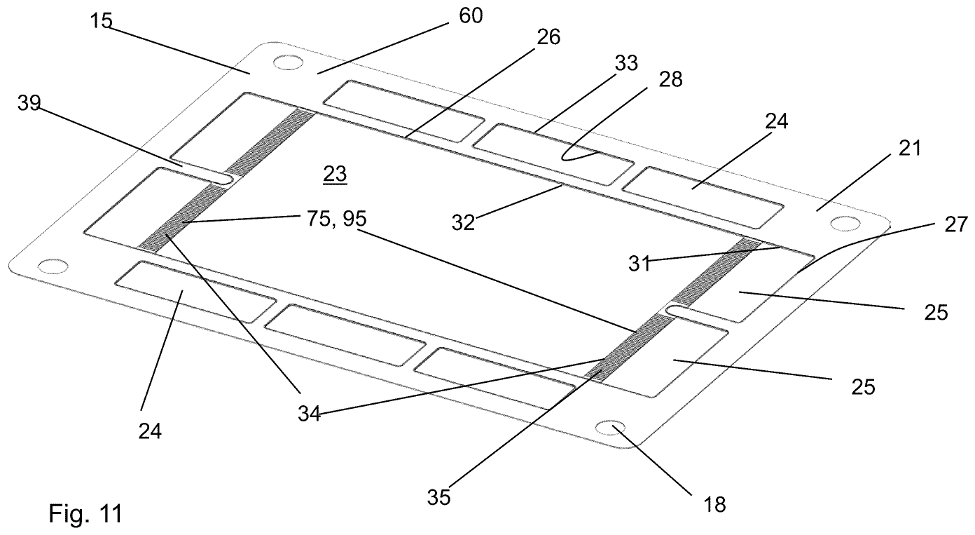

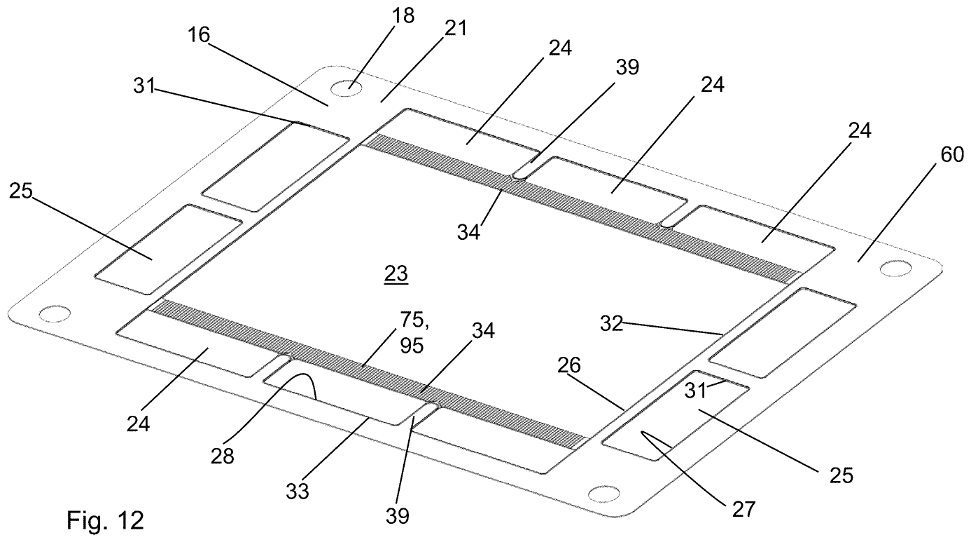

Further details of the cell frame 15, 16 are shown in FIGS. 11, 12.

The outer region 60 of the cell frame 15, 16 comprises a recess 23 having an inner edge 26. The outer region 60 or the inner edge 26 of the recess 23 surrounds an electrochemically active region in the shape of a frame, with the recess 23 extending over this region. The recess 23 may be brought into alignment with the electrochemically active region of the flow field 3 of the bipolar plate 1 of FIG. 3, so that the recess 23 and the electrochemically active region of the bipolar plate 1 overlap.

The cell frame 15, 16 also has at least one through-opening 24, 25 having an inner edge 27, 28, for the fluid to pass through. The through-openings 24, 25 of the cell frame 15, 16 are typically brought into alignment with the through-openings 4, 5 of the bipolar plate 1 of FIG. 3. The through-openings 4, 24 and through-openings 5, 25 that are stacked on top of each other in an electrochemical cell form fluid lines 29 through which reaction media/product media can flow. The cell frame 15, 16 can, for example, have at least two through-openings 24, 25. In the figures, the through-openings 24, 25 of the cell frame 15, 16/the through-openings 4, 5 of the bipolar plate are provided with a similar reference sign—terminating on the same cipher 4 or 5—if they transport fluid(s) flowing on the anode side or the cathode side of the bipolar plate 1. For example, in the case of an electrolyzer, the through-openings 5, 25 are designed to remove the hydrogen generated in the electrochemical cell. The through-openings 4, 24 are designed for the ingress of water/the egress of water and oxygen. The cell frame 15, 16 has a first side 21 (front side) and a second side 22 (rear side), which are arranged opposite each other.

The cell frame 15, 16 often has a first elastomeric sealing element 31, 33, which rests against the inner edge 27, 28 of the through-opening 24, 25 and projects laterally into the through-opening 24, 25 in order to seal the through-opening 24, 25. The first sealing element 31, 33 may lie circumferentially on the inner edge 27, 28 of the through-opening 24, 25, that is, the first sealing element 31 may be molded onto the inner edge 27, 28 in an edge-molding process.

In addition, the cell frame 15, 16 can have a second elastomeric sealing element 32, which lies against the inner edge 26 of the recess 23 and projects laterally into the recess 23 in order to seal the recess 23. The second sealing element 32 may be molded onto the inner edge 26 of the recess 23 in an edge-molding process. The first sealing element 31, 33 and/or the second sealing element 32 may be electrically insulating.

When the cell frame 15, 16 is used as intended, the first sealing element 31 and the second sealing element 32 may be in contact with the respective fluid flowing through the through-opening 24, 25 and/or through the recess 23. The outer region 60 or the material of the outer region 60 cannot be in contact with the fluid (or fluids) due to the sealing of the sealing elements 31, 32. This makes it possible to use materials for the outer region 60 that may not be chemically resistant to the fluids used and/or are incompatible with the fluids used, such as H₂, O₂ and H₂O, under the operating conditions of the electrochemical cell. This makes it possible to use less expensive and/or mechanically more advantageous materials, which cannot be used in conventional systems in which the material of the outer region 60 comes into contact with the fluids.

In one embodiment, the elastomeric connecting section 80, the elastomer region 90 of the fluid guide structure 34, the first elastomeric sealing element 31, 33 and the second elastomeric sealing element 32 are formed from the same elastomer and may be formed as integral components of a single elastomeric element 30. Examples of elastomers are FKM (fluoroelastomer), silicone rubber or NBR rubber (nitrile butadiene rubber), PUR (polyurethane), NR (natural rubber), FFKM (perfluoro rubber), SBR (styrene butadiene rubber), BR (butadiene rubber), FVMQ (fluorosilicone), CSM (chlorosulfonated polyethylene), HNBR (hydrogenated nitrile-butadiene rubber), ACM (acrylate rubber), AEM (acrylate-ethylene rubber), EPDM (ethylene-propylene-diene rubber), IIR (butyl rubber) or mixtures of the aforementioned materials.

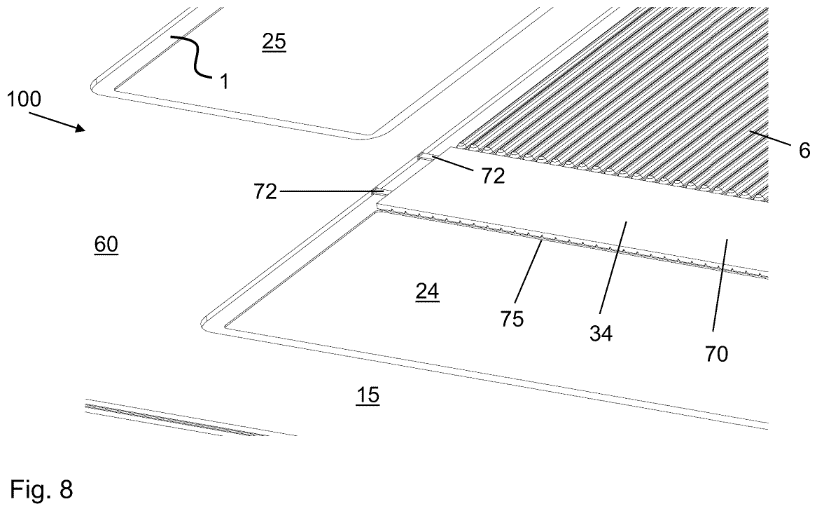

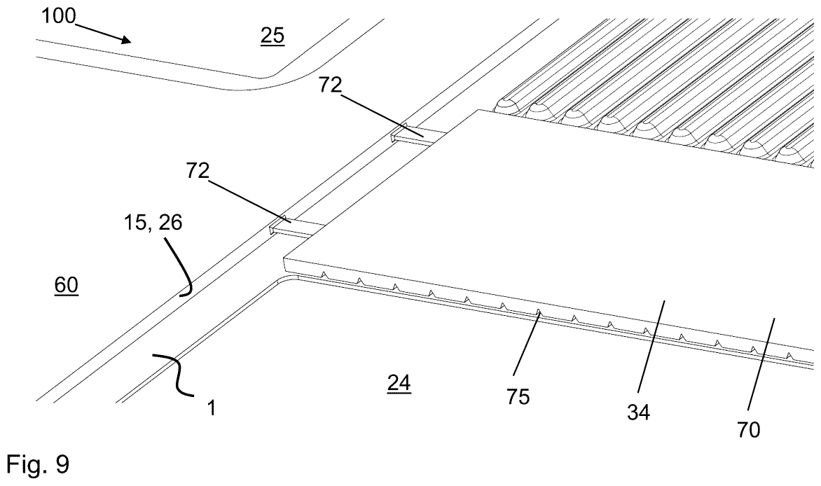

The elastomeric connecting section 80 is omitted in FIGS. 8-9 for better visibility. FIGS. 8-9 show an embodiment of the cell frame 15, 16 in which, in addition to the elastomeric connecting section 80, two metallic reinforcing elements 72 extend, in the form of webs, from the outer region 60 to the metallic support element 70 and optionally connect one of them with the other. In the example embodiment shown, there are two webs 72; however, fewer or more than two webs 72 are also conceivable. The reinforcing elements 72 can be made from the same plate body as the outer region 60. It is also conceivable that the metallic support element 70 is made from the same plate body, whereby the material of the support element 70 may differ from the material of the outer region 60. In one variant, the reinforcing elements are part of the support element 70 and are therefore made of the same material, but then differ from the material of the outer region 60. It is possible, for example, that the outer region 60, the reinforcing elements 72 and possibly also the metallic support element 70 are produced by stamping or cutting a single plate body, metal sheet or blank. Subsequently or previously, the reinforcing elements 72 can be produced by thinning or embossing the plate body, metal sheet or blank. In the same embossing step, the channels 75 can optionally be formed into the support element 70. The elastomeric material is then applied, e.g. injection-molded, forming the elastomeric connecting section 80. The reinforcing elements 72 may be embedded in the material of the elastomeric connecting section 80. The metallic reinforcing elements 72 can provide additional stability to the fluid guide structure 34.

The recess 23 and the through-opening 24, 25 can be formed, in particular cut-out as a common opening in the outer region 60. In other words, the recess 23 and the through-opening(s) 24, 25 merge into one another before the sealing elements 31, 32, 33 are molded onto the outer region 60 and/or before the sealing elements 31, 32, 33 are connected to the outer region 60, that is they are not separated from one another by material of the outer region 60. The spatial separation of the through-opening(s) 24, 25 and the recess 23 may only be achieved by the provision of the fluid guide structure 34, whereby the fluid guide structure 34 enables the fluidic connection between the through-opening 24, 25 and the recess 23. The recess 23 and the through-opening 24, 25 can therefore be spatially separated from each other only by the fluid guide structure 34.

Partition elements 39 such as finger-shaped webs can be provided in the layer 20 in order to fluidically separate neighboring through-openings 24, 25, which can pass the same fluids. The fluid guide structure 34 may be connected to end sections of the finger-shaped partition elements 39. The optional partition elements 39 give the cell frame 15, 16 additional mechanical stability by shortening the distance to be bridged by the fluid guide structure 34.

FIGS. 4-10 already show the arrangement 100. The arrangement 100 comprises the cell frames 15, 16 and the bipolar plate 1 of FIG. 3. Here, the cell frames 15, 16 are arranged on both sides of the bipolar plate 1, i.e. on opposite sides 17, 19 of the bipolar plate 1, so that a sandwich arrangement of the elements 15, 1, 16 is formed.

Further, each cell frame 15, 16 and the bipolar plate 1 are positioned relative to each other such that the through-openings 4, 5 of the bipolar plate 1 and the through-openings 24, 25 of the cell frames 15, 16 are arranged one above the other to form fluid lines 29. Furthermore, the cell frames 15, 16 and the bipolar plate 1 are aligned in such a way that the outer region 60 surrounds the flow field 3 with the electrochemically active region of the bipolar plate 1. The first sealing element 31, 33 of the cell frames 15, 16 is configured to seal the through-opening 4, 5 of the bipolar plate 1. Furthermore, the second sealing element 32 of the cell frames 15, 16 is configured to seal the electrochemically active region of the flow field 3 of the bipolar plate 1.

Each cell frame 15, 16 is generally positioned so that the fluid guide structures 34 face the bipolar plate 1. The recesses 75, 95 are thus covered by the bipolar plate 1.

It may be provided that the through-opening 4, 5 formed in the bipolar plate 1 is smaller than the corresponding through-opening 24, 25 formed in the cell frame 15, 16. In other words, the bipolar plate 1 protrudes laterally further into the fluid line 29 formed by the through-opening 4, 5 and the corresponding through-opening 24, 25 than the cell frame 15, 16 or the sealing elements 31, 32, 33 of the cell frame.

For improved sealing of the regions 3, 4, 5 of the bipolar plate 1, it is advantageous if the first sealing element 31, 33 and/or the second sealing element 32 of the layer 20 contact the bipolar plate 1. This also ensures that the outer region 60 does not come into contact with the fluid during operation of the electrochemical cell. This can enable a plate body of the outer region 60 and a plate body of the bipolar plate 1 to be made of different materials. In addition, it may be the case that the plate body of the outer region 60 is composed of several parts, i.e. segmented using methods from the prior art.

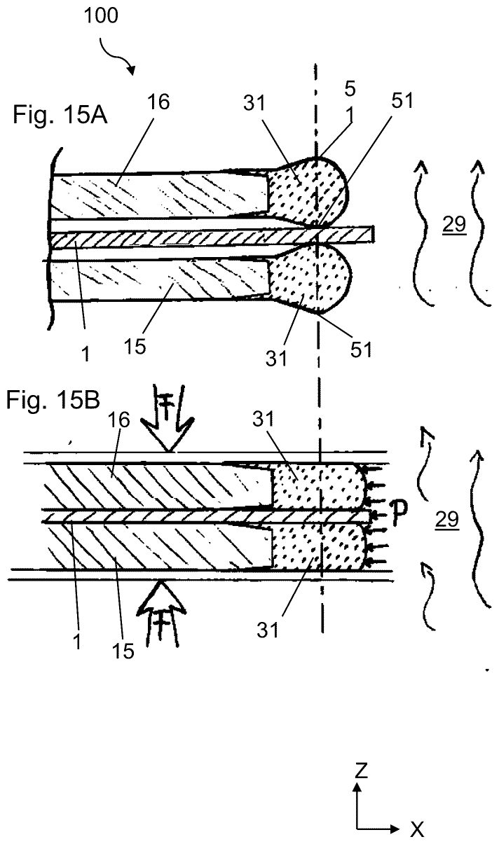

The first sealing element 31, 33 and the second sealing element 32 protrude in a vertical direction beyond the first side 21 of the outer region 60 and/or the second side 22 of the outer region 60 in an uncompressed state of the cell frame 15, 16, see FIG. 15A. The vertical direction is defined in such a way that it is parallel to the pressing force and perpendicular to the surface normal of the cell frame 15, 16, see z-direction in FIGS. 15A and 15B. The protrusion 51 of the respective sealing element 31, 32, 33, which thus protrudes beyond the flat sides 21, 22 of the outer region 60 in the uncompressed state of the cell frame 15, 16, is clearly recognizable, particularly in FIG. 15A. When the cell frame is compressed together with the bipolar plate 1, the protrusion 51 is compressed laterally in the direction of the recess 23 or the through-opening 24, 25, so that the corresponding sealing element 31, 32, 33 is essentially flush with the outer region 60 in the compressed state, cf. FIG. 15B. The sealing elements 31, 32, 33 can be dimensioned or designed in such a way that their lateral extension in the compressed state of the cell frame 15, 16 does not protrude beyond the bipolar plate 1, or more precisely: an edge of the bipolar plate 1 in the region of the through-opening 4, 5, into the fluid line 29.

According to the figures shown, the cell frame 15, 16 is designed to be arranged in a cathode chamber or in an anode chamber of an electrolyzer. However, the present disclosure is not limited to this. The cell frame 15, 16 can also be used in a fuel cell stack or in other electrochemical systems.

In FIGS. 11-14 it is left open whether the fluid passages 75, 95 are part of the support element 70 or the elastomer region 90. FIGS. 11-14 therefore cover both applications.

FIGS. 11 and 12 further show that in the cathode-side cell frame 15, the through-openings 24 for the passage of water and/or oxygen are completely sealed all around by the first sealing element 31, while hydrogen generated in the electrochemically active region can pass through the fluid guide structure 34 to the through-openings 25 and the fluid line 29.

Accordingly, in the anode-side cell frame 16, the through-openings 25 for the passage of hydrogen are completely sealed by the first sealing element 31, while water can pass from the through-openings 24 through the fluid guide structure 34 to the electrochemically active region or the flow field 3. The generated oxygen can flow from the electrochemically active region together with the unreacted water through the fluid guide structure 34 to the through-openings 24.

Thus, in the sandwich arrangement 100 of FIGS. 15A and 15B, one cell frame 15, 16 completely seals the through-openings for one kind of medium all around, while the other cell frame 16, 15 permits fluid flow of this very medium through the fluid guide structure 34, not shown here, from or to the electrochemically active region of the bipolar plate.

The arrangement 100 can comprise further layers. For example, the arrangement 100 also comprises at least one insulation layer, which is arranged between the cell frame 15, 16 and the bipolar plate 1. Alternatively, the cell frame 15, 16 can be arranged between the insulation layer and the bipolar plate 1. Further additional elements are shown in FIG. 1, which can be combined with the arrangement 100. Thus, the arrangement can further comprise a membrane electrode assembly (MEA), which is arranged on the side of the cell frames 15, 16 facing away from the bipolar plate 1 and/or a porous transport layer (PTL) or gas diffusion layer (GDL), which is arranged between the MEA and the flow field 3 of the bipolar plate 1.

It should be noted that the fluid guide structure 34 may comprise a plurality of separate metallic support elements 70. For example, one support element 70 can be provided for each opening 24 or 25. Furthermore, more than one support element 70 per opening can also be provided. For example, two support elements 70 and the elastomer region can be arranged in a sandwich-like manner in relation to one another.

It is apparent to a person skilled in the art that the features of FIGS. 1-17 described above can be combined with each other, provided they do not contradict each other, and are claimed individually.

1. A cell frame for an electrochemical system, comprising an outer region that defines at least one through-opening and a flow field, and a fluid guide structure arranged between the through-opening and the flow field, the fluid guide structure configured to guide a fluid from the through-opening to the flow field or vice versa, wherein the fluid guide structure has a metallic support element, which is connected to the outer region of the cell frame via at least one elastomeric connecting section.

2. The cell frame according to claim 1, wherein the outer region and the metallic support element are formed from different materials.

3. The cell frame according to claim 2, wherein the metallic support element is formed from stainless steel, titanium or a titanium alloy and/or wherein the outer region is formed from aluminum or an aluminum alloy, plastic or stainless steel.

4. The cell frame according to claim 3, wherein the fluid guide structure comprises a plurality of fluid passages for passing fluid therethrough, wherein the fluid passages are molded into the metallic support element.

5. The cell frame according to claim 4, wherein the metallic support element in a region between the fluid passages and/or outside the fluid passages, has a thickness that is the same as a thickness of the outer region.

6. The cell frame according to claim 1, wherein the fluid guide structure comprises an elastomer region that adjoins the elastomeric connecting section and that extends between the through-opening and the flow field.

7. The cell frame according to claim 6, wherein the fluid guide structure comprises a plurality of fluid passages for passing fluid therethrough, the fluid passages being formed in the elastomer region.

8. The cell frame according to claim 7, wherein the metallic support element overlaps with the fluid passages, and wherein the support element is arranged on the fluid passages of the elastomer region or is arranged on a side of the elastomer region opposite the fluid passages.

9. The cell frame according to claim 8, wherein the metallic support element and the elastomer region in the region outside the fluid passages have a combined thickness which, at least in a compressed state of the cell frame, is the same as a thickness of the outer region.

10. The cell frame according to claim 1, wherein the elastomeric connecting section comprises a sealing line support and/or a sealing lip extending between the metallic support element and the outer region.

11. The cell frame according to claim 1, wherein the elastomeric connecting section is connected to the outer region and/or the metallic support element in a materially cohesive manner and/or in a non-detachable form-fitting manner and/or in a conditionally detachable form-fitting manner.

12. The cell frame according to claim 1, wherein the outer region and/or the metallic support element are configured as a flat plate.

13. The cell frame according to claim 1, wherein the cell frame has an inner edge and a first elastomeric sealing element in a region of the through-opening, wherein the elastomeric sealing element is molded onto the inner edge of the through-opening.

14. The cell frame according to claim 13, wherein the elastomeric connecting section, an elastomer region of the fluid guide structure and/or the first elastomeric sealing element are formed from the same elastomer.

15. An arrangement for an electrochemical system, comprising the cell frame according to claim 1 and a bipolar plate, wherein the bipolar plate has at least one through-opening and a flow field with an electrochemically active region, wherein the cell frame and the bipolar plate are positioned relative to each other in such a way that through-openings of the bipolar plate and the through-openings of the cell frame are arranged one above the other and the cell frame surrounds the flow field with the electrochemically active region of the bipolar plate.

16. The arrangement according to claim 15, wherein a plate body of the outer region of the cell frame and a plate body of the bipolar plate are made of different materials.

17. An electrochemical system, comprising a plurality of stacked arrangements according to claim 15.

18. The cell frame according to claim 11, wherein the elastomeric connecting section is molded onto the outer region and/or the metallic support element.

19. The cell frame according to claim 12, wherein the outer region and/or the metallic support element are configured as a smooth sheet.

20. The cell frame according to claim 14, wherein the elastomeric connecting section, the elastomer region of the fluid guide structure and/or the first elastomeric sealing element are formed as integral components of a single elastomeric element.
